(19) United States
(12) Patent Application Publication
(10) Pub. No.: US 2011/0063561 A1
(43) Pub. Date: Mar. 17, 2011

(54) LIQUID CRYSTAL DISPLAY PANEL AND MANUFACTURING METHOD THEREOF

(75) Inventors: Yongzhi SONG, Beijing (CN); Lujiang HUANGFU, Beijing (CN); Huiyue LUO, Beijing (CN); Xu WANG, Beijing (CN)

(73) Assignee: BEIJING BOE OPTOELECTRONICS TECHNOLOGY CO., LTD., Beijing (CN)

(21) Appl. No.: 12/879,201

(22) Filed: Sep. 10, 2010

(30) Foreign Application Priority Data
Sep. 14, 2009 (CN) 200910092627.3

(51) Int. Cl. G02F 1/1339

(52) U.S. Cl. 349/153; 349/190

(57) ABSTRACT

A liquid crystal display panel and a manufacturing method thereof are provided. The liquid crystal display panel comprises: a first substrate and a second substrate bonded to each other; a liquid crystal layer filled between a display region of the first substrate and a display region of the second substrate; and a sealant formed between a periphery region of the first substrate and a periphery region of the second substrate. A reflective layer is formed in the periphery region of the first substrate or in the periphery region of the second substrate, and the reflective layer is adapted to reflect UV light to the sealant in a process of assembling the first substrate and the second substrate.

### BACKGROUND

Embodiments of the present invention relate to a liquid crystal display panel and a manufacturing method thereof.

A liquid crystal display panel employed in a thin film transistor liquid crystal display (TFT-LCD) comprises a color filter substrate, an array substrate and a liquid crystal layer filled between the color filter substrate and the array substrate. An “assembling process” refers to the process of assembling the color filter substrate and the array substrate which have been prepared previously, and the procedure is performed as follows. Firstly, liquid crystal molecules are dropped on the display region of one of the color filter substrate and the array substrate by an ODF (One Drop Fill) method, and sealant is uniformly applied on the periphery region of the other one of the color filter substrate and the array substrate. Then, the color filter substrate and the array substrate are aligned and attached to each other, the sealant is cured, and thereby the array substrate and the color filter substrate are bonded together. The substrate to which the sealant is applied may be the color filter substrate, and correspondingly the substrate on which the liquid crystal molecules are dropped may be the array substrate. Or, the substrate to which the sealant is applied may be the array substrate, and correspondingly the substrate on which the liquid crystal molecules are dropped may be the color filter substrate.

In addition, the color filter substrate may be provided with black matrix. The black matrix is typically formed by opaque resin materials, for example, photosensitive polymers such as photo-crosslinkable polyvinylalcohol bearing styrylpyridinium group (PVA-SbQ) and the like or photo-induced free radical polymerized acrylic resin and the like. The black matrix is good in light absorption but poor in heat-resistance and light-resistance. Where the sealant and the black matrix on the color filter substrate partially overlap with each other, when UV light is irradiated from the color filter substrate side in the process of curing the sealant, the UV light incident on the black matrix may be absorbed by the black matrix. Thus, the utilization ratio of the UV light is decreased. In addition, the intensity of the light incident on the portion of the sealant provided below the black matrix is lower than that of the light incident on the other portions of the sealant, thus the portion of the sealant provided below the black matrix can not be sufficiently cured and the curing degree of such portion is about 40% to 65% of that of the other portions of the sealant. Therefore, in the course of conveying the liquid crystal display panel from the platform for curing the sealant by UV light to another platform for curing the sealant by heat, misalignment between the color filter substrate and the array substrate may occur because of insufficient curing of the portion of the sealant provided below the black matrix, and thus the yield is decreased. Furthermore, since the black matrix is poor in light-resistance and heat-resistance, the properties of the black matrix may be chemically changed under long-time heat and light irradiation, and thus the defects in the liquid crystal display panel are increased.

In addition, where the sealant and the black matrix on the color filter substrate do not overlap with each other, in the process of curing the sealant by the UV light, the incident UV light may transmit through the sealant to the outside of the liquid crystal display panel, and thus the portion of the UV light transmitted to the outside of the liquid crystal display panel can not be utilized and the utilization ratio of the UV light is decreased.

### SUMMARY

According to an aspect of the invention, a liquid crystal display panel is provided. The liquid crystal display panel comprises: a first substrate and a second substrate bonded to each other; a liquid crystal layer filled between a display region of the first substrate and a display region of the second substrate; and a sealant formed between a periphery region of the first substrate and a periphery region of the second substrate. A reflective layer is formed in the periphery region of the first substrate or in the periphery region of the second substrate, and the reflective layer is adapted to reflect UV light to the sealant in a process of assembling the first substrate and the second substrate.

According to another embodiment of the invention, a method of manufacturing a liquid crystal display panel is provided. The method comprises: preparing a first substrate and a second substrate, wherein a reflective layer is formed in a periphery region of the first substrate or in a periphery region of the second substrate; applying a sealant in the periphery of one of the first substrate and the second substrate, dropping liquid crystal molecules on a display region of the other of the first substrate and the second substrate, and attaching the first substrate and the second substrate to each other; and curing the sealant by UV light so that the first substrate and the second substrate are bonded together, wherein the UV light incident on the reflective layer is reflected back to the sealant by the reflective layer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is structural view showing a periphery region of a liquid crystal display panel according to a first embodiment of the invention; and

FIG. 2 is structural view showing a periphery region of a liquid crystal display panel according to a second embodiment of the invention.

### DETAILED DESCRIPTION

Hereinafter, embodiments of the invention will be described in detail with reference to the accompanying drawings. It should be noted that, the following embodiments are described for illustration only but not in a limited way, and modifications, combinations and alterations can be made based on the these embodiments without departing from the spirit and scope of the invention.

The liquid crystal display panel according to an embodiment of the invention comprises a first substrate and a second substrate. The first substrate and the second substrate are opposite to each other. Liquid crystal molecules are filled between a display region of the first substrate and a display region of the second substrate to form a liquid crystal layer. A sealant is provided between a periphery region (i.e., non-display region) of the first substrate and a periphery region of the second substrate. The sealant surrounds the liquid crystal layer. A reflective layer is provided on the periphery region of the first substrate or on the periphery region of the second substrate. In assembling the first substrate and the second substrate, the reflective layer reflects UV light so that the UV light is incident on the sealant again. The UV light reflected to the sealant is again used to cure the sealant, and thus the utilization ratio of the UV light can be increased and the probability of causing defects in the liquid crystal display panel can be decreased. The periphery region is provided outside the display region.

The two substrates to form the liquid crystal display panel comprise a color filter substrate and an array substrate. The color filter substrate is an example of the first substrate, and the array substrate is an example of the second substrate. The assembling process of the color filter substrate and the array substrate is performed as follows. Firstly, the sealant is applied on the periphery region of one of the color filter substrate and the array substrate, and the liquid crystal molecules are dropped on the display region of the other one of the color filter substrate and the array substrate. Then, the substrate with the sealant is reversed and disposed on the substrate with the liquid crystal, and then, the display regions and the periphery regions of the two substrates are aligned with each other, respectively. Finally, the sealant is cured so that the two substrates are bonded together.

Specifically, the assembling process may be performed in different ways depending on the size of the liquid crystal display panel. For example, if the LCD panel has a small size (for example, the size of the LCD panel is 8.9 inches and the like), the sealant is applied on the array substrate, the liquid crystal molecules are dropped on the color filter substrate, and then the array substrate is reversed and disposed on the color filter substrate. In addition, if the LCD panel has a large size (for example, the size of the LCD panel is 32 inches, or 47 inches and the like), the sealant is applied on the color filter substrate, the liquid crystal molecules are dropped on the array substrate, and then the color filter substrate is reversed and disposed on the array substrate.

### First Embodiment

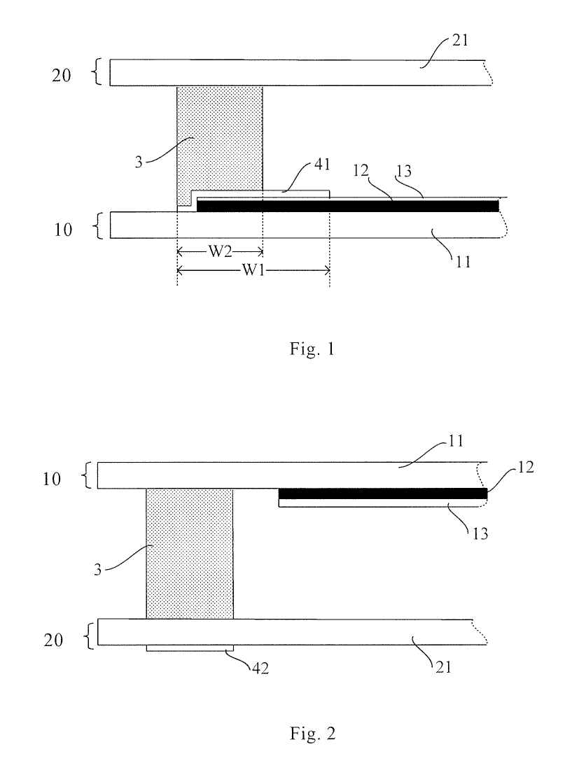

FIG. 1 is structural view showing the periphery region of the liquid crystal display panel according to a first embodiment of the invention. In this embodiment, the reflective layer (referred to as a first reflective layer hereinafter) is formed on the surface of the color filter substrate on the sealant side in the periphery region, that is, the first reflective layer and the sealant are provided on the same side of the color filter substrate. As shown in FIG. 1, the liquid crystal display panel in this embodiment comprises the color filter substrate 10 and the array substrate 20. The array substrate 20 and the color filter substrate 10 are opposite to each other in the thickness direction of the liquid crystal display panel.

The array substrate 20 mainly comprises a second transparent substrate 21 and array patterns (not shown) formed on the second transparent substrate 21. For example, the array patterns comprise gate lines, data lines and pixel electrodes. Thin film transistors are formed at the intersections of the gate lines and the date lines as switching elements.

The color filter substrate 10 mainly comprises a first transparent substrate 11 and color filter patterns formed on the first transparent substrate 11. For example, the color filter patterns comprise a black matrix layer 12, a red resin pattern (not shown), a blue resin pattern (not shown), a green resin pattern (not shown) and a common electrode 13. In addition, the first reflective layer 41 is formed in the periphery region of the color filter substrate 10. The first reflective layer 41 covers a region of the color filter substrate for applying or aligning the sealant 3, and the first reflective layer 41 partially overlaps with the black matrix layer 12. The first reflective layer 41 is used to reflect the UV light incident on it.

In the process of curing the sealant 3 with UV light, the irradiation region of the UV light generally is larger than the application region of the sealant. In this case, in order to improve the utilization ratio of the UV light and prevent the UV light from irradiating onto the black matrix layer 12, the width W1 of the first reflective layer 41 is designed according to the irradiation region of the UV light so that the width W1 of the first reflective layer 41 is substantially equal to the width of the irradiation region of the UV light. For example, the width of the first reflective layer 41 is 1.1 to 1.7 times larger than the width W2 of the sealant 3, and preferably, the width W1 of the first reflective layer 41 is 1.5 times larger than the width W2 of the sealant 3. The first reflective layer 41 may be formed by a metal material such as aluminum, copper, alloy of molybdenum and aluminum and the like. In addition, the thickness of the first reflective layer 41 is appropriately selected. If the thickness of the first reflective layer 41 is too small, the UV light can not be effectively reflected. On the other hand, if the thickness of the first reflective layer 41 is too big, the thickness of the LCD panel is undesirably increased. For example, the thickness of the first reflective layer 41 is 0.1 μm to 0.4 μm, and preferably, the thickness of the first reflective layer 41 is 0.1 μm.

Hereinafter, the LCD panel in this embodiment will be explained by taking the assembling process of a small-sized LCD panel as an example. The assembling process of the small-sized LCD panel comprises the following steps.

Firstly, sealant is applied on the periphery region of the array substrate 20, and the liquid crystal molecules are dropped on the display region of the color filter substrate 10.

Then, the array substrate 20 is reversed and disposed on the color filter substrate 10. At this time, the display regions of the color filter substrate 10 and the array substrate 20 are aligned with each other, and the periphery regions of the color filter substrate 10 and the array substrate 20 are aligned with each other as well.

Finally, the sealant is cured. The sealant is cured by a two-stage process including a curing process with UV light and a curing process with heat. Typically, the curing process with UV light is firstly performed, and after that, the curing process with heat is performed. In the curing process with UV light, the UV light is incident from the side of the array substrate.

Since the width W1 of the first reflective layer is substantially equal to the width of the irradiation region of the UV light and larger than the width W2 of the sealant 3, one portion of the UV light transmitted through the array substrate is directly incident on the sealant 3, and the other portion of the UV light transmitted through the array substrate is directly incident on the first reflective layer 41. The UV light incident on the first reflective layer 41 is reflected back by the first reflective layer 41 and does not enter into the black matrix layer 12. The UV light incident on the sealant 3 is used to cure the sealant 3. In addition, a portion of the UV light incident on the sealant 3 may transmit through the sealant 3 and be incident on the first reflective layer 41, and in this case, such portion of the UV light will be reflected back to the sealant 3 by the first reflective layer 41. In this way, the utilization ratio of the UV light can be improved, and the UV light can be effectively prevented from entering into the black matrix layer 12.

In the region that the sealant 3 and the black matrix layer 12 overlaps with each other, there exist an interface between the first reflective layer 41 and the common electrode 13 and another interface between the first reflective layer 41 and the sealant 3.

Since the common electrode 13 is typically formed by transparent conductive film such as indium tin oxide (ITO) and the first reflective layer 41 is formed by a metal material with high reflectivity such as aluminum, copper, alloy of molybdenum and aluminum and the like, the common electrode voltage applied on the array substrate can be conducted to the common electrode 13 on the color filter substrate 10 by the first reflective layer 41. The oxygen element or radical in ITO of the common electrode 13 strongly attracts electrons and thus strong interaction can easily occurs between the common electrode 13 and the first reflective layer 41. Therefore, at the interface between the first reflective layer 41 and the common electrode 13, the first reflective layer 41 is firmly bonded with the common electrode 13.

Below, the interface between the first reflective layer 41 and the sealant 3 will be discussed. The sealant 3 is formed by epoxy resin rich in epoxy groups. The electrons around oxygen mainly move between oxygen and carbon, and thus the other side of oxygen lacks electron cloud and easily interacts with the atoms on the metal surface so that an interaction similar to bonds among atoms in the oxides generates. Therefore, at the interface between the first reflective layer 41 and the sealant 3, the first reflective layer 41 is firmly bonded with the sealant 3.

In the LCD panel according to this embodiment, the first reflective layer is formed in the periphery region of the color filter substrate. Thus, in the process of curing the sealant by UV light, the utilization ratio of the UV light can be improved. In addition, the UV light can be prevent from entering into the color filter patterns of the color filter substrate, and therefore the properties of the color filter patterns such as black matrix can be effectively prevented from being chemically changed and the probability of causing defects in the liquid crystal display panel can be decreased.

### Second Embodiment

FIG. 2 is structural view showing the periphery region of the liquid crystal display panel according to a second embodiment of the invention. The LCD panel in this embodiment is different from the first embodiment in that, the reflective layer (referred to as a second reflective layer 42 hereinafter) is formed on the surface of the array substrate 20 opposed the sealant side in the periphery region, that is, the second reflective layer 42 and the sealant 3 are provided on two opposed surfaces of the array substrate 10, respectively. The second reflective layer 42 and the array patterns are formed on two opposed surfaces of the second transparent substrate 21, and the second reflective layer 42 is formed on the surface of the second transparent substrate 21 facing the backlight. The second reflective layer 42 covers at least a region of the array substrate 20 for applying or aligning the sealant 3. The second reflective layer 42 is used to reflect the UV light incident on it. The width of the second reflective layer 42 is designed mainly depending on the width of the sealant 3 and the distance between the sealant 3 and the array patterns. In order to effectively reflect the UV light, the second reflective layer 42 can not be designed to have a too small width. In addition, in order to decrease the adverse influence on the array substrate resulting from the reflected light, the second reflective layer 42 can not be designed to have a too large width. For example, the width of the second reflective layer 42 is 0.9 to 1.4 times larger than the width of the sealant, and preferably, the width of the second reflective layer 42 is substantially equal to the width of the sealant. In this way, the second reflective layer 42 can effectively reflect the UV light back into the sealant 3 and prevent the light from the backlight from entering the sealant 3, and at the same time, the second reflective layer 42 can not block the light from the backlight from entering into the array patterns and adversely influencing the display of the LCD panel.

The thickness of the second reflective layer 42 is designed mainly depending on the process precision and the thickness of the LCD panel. In order to more easily form the second reflective layer 42, the second reflective layer 42 can not be designed to have a too small thickness. In addition, in order to decrease the contribution of second reflective layer 42 to the thickness of the LCD panel, the second reflective layer 42 can not be designed either to have a too large thickness. For example, the thickness of the second reflective layer 42 is 0.1 μm to 0.4 μm, and preferably, the thickness of the second reflective layer 42 is 0.1 μm. Thus, the second reflective layer 42 can be easily formed and the influence of the second reflective layer 42 on the thickness of the LCD panel can be decreased.

In this embodiment, the second reflective layer 42 is provided on the array substrate 20. In this way, advantages can be obtained both in the manufacturing process of the LCD panel and in the operation process of the LCD panel. Such advantages are described as follows.

(1) In the assembling process of manufacturing the LCD panel, the second reflective layer 42 can improve the utilization ratio of the UV light. The advantage will be explained further by applying the LCD panel in this embodiment into the assembling process of the large-sized LCD panel as an example. The assembling process of the large-sized LCD panel comprises the following steps.

Firstly, the sealant is applied on the periphery region of the color filter substrate 10, and the liquid crystal molecules are dropped on the display region of the array substrate 20.

Then, the color filter substrate 10 is reversed and disposed on the array substrate 20. At this time, the display regions of the color filter substrate 10 and the array substrate 20 are aligned with each other, and the periphery regions of the color filter substrate 10 and the array substrate 20 are aligned with each other as well.

Finally, the sealant is cured. The sealant is cured by a two-stage process including a curing process with UV light and a curing process with heat. Typically, the curing process with UV light is firstly performed, and after that, the curing process with heat is performed. In the curing process with UV light, the UV light is incident from the side of the color filter substrate.

In addition, when the UV light irradiated from the color filter substrate side is incident on the sealant 3 to cure the sealant 3, a portion of the UV light incident on the sealant 3 may transmit through the sealant 3 and the second transparent substrate 21 and be irradiated on the second reflective layer 42, and in this case, such portion of the UV light will be reflected back into the sealant 3 by the second reflective layer 42 to cure the sealant 3 once again. In this way, the utilization ratio of the UV light can be improved and the time for curing the sealant can be shortened. In addition, the probability that the liquid crystal layer is contaminated by un-cured sealant material can be decreased, and thus the display quality of the LCD panel can be secured and the defects in the LCD panel can be decreased.

(2) In the operation process of the LCD panel, the second reflective layer 42 can block the light of the back light from entering into the sealant, and thus the sealant can be prevented from being damaged by the light of backlight.

The sealant 3 is formed by epoxy resin rich in epoxy groups. The properties of the epoxy resin may be chemically changed under long-time light irradiation and heat, generating impurities. The impurities may contaminate the liquid crystal layer, and thus the display quality of the LCD panel may be decreased and defects may occur in the LCD panel.

During the operation of the LCD panel, the backlight is provided on the side of the array substrate, opposite to the color filter substrate, to supply light for displaying images. The light of the backlight is incident from the array substrate. Since the LCD panel continuously operates for a long time, the adverse influence of the light irradiation and heat of the back light on the sealant can not be ignored.

In this embodiment, the second reflective layer 42 is formed on the surface of the array substrate facing the backlight. When the light of the backlight is incident on the second reflective layer 42, the second reflective layer 42 reflects back the light, and thus the light can be shielded from entering into the sealant and the adverse influence of the light of the backlight on the sealant can be decreased. In addition, the heat accumulated in the sealant due to the light irradiation can be decreased as well, and thus the adverse influence of heat on the sealant can be decreased. Therefore, the lifetime of the sealant can be prolonged and the defects in the LCD panel can be decreased.

According to this embodiment, the second reflective layer is formed on the surface of the array substrate opposite to the color filter substrate in the periphery region. The second reflective layer and the array patterns are respectively formed on two opposed surfaces of the second transparent substrate, and thus the reflective layer will not adversely influence the array patterns. In addition, in the assembling process of the LCD panel, the utilization ratio of the UV light for curing the sealant can be improved by the second reflective layer. In addition, in the operation process of the LCD panel, the light and heat from the backlight to the sealant can be shielded by the second reflective layer. Thus, the adverse influence on the properties of the sealant can be decreased, the lifetime of the sealant can be prolonged and the defects in the LCD panel can be decreased.

### Third Embodiment

A method of manufacturing a LCD panel according to this embodiment may comprise the following steps.

Step 31 of preparing a first substrate (such as a color filter substrate) and a second substrate (such as an array substrate) by patterning processes, wherein a reflective layer is formed in a periphery region of the first substrate or the second substrate.

The two substrates constituting the LCD panel comprise the color filter substrate and the array substrate. The color filter substrate may be the first substrate in this embodiment, and the array substrate may be the second substrate in this embodiment.

If the reflective layer (referred to as a first reflective layer hereinafter) is formed in the periphery region of the color filter substrate, the first reflective layer is provided on the surface of the color filter substrate in the periphery region facing the sealant side, that is, the first reflective layer and the sealant are provided on the same side of the color filter substrate.

If the reflective layer (referred to as a second reflective layer hereinafter) is formed in the periphery region of the color filter substrate, the second reflective layer is provided on the surface of the array substrate in the periphery region opposite to the sealant, that is, the second reflective layer and the sealant are provided on two opposed surfaces of the array substrate, respectively.

Step 32 of applying the sealant in the periphery of one of the first substrate and the second substrate, dropping the liquid crystal molecules on the display region of the other one of the first substrate and the second substrate, and attaching the first substrate and the second substrate to each other.

In the case of manufacturing a small-sized LCD panel, the sealant is applied on the array substrate and the liquid crystal molecules are dropped on the color filter substrate. In the case of manufacturing a large-sized LCD panel, the sealant is applied on the color filter substrate and the liquid crystal molecules are dropped on the array substrate.

Step 33 of curing the sealant by UV light so that the first substrate and the second substrate are bonded together, wherein the UV light incident on the reflective layer (i.e., the first reflective layer and the second reflective layer) is reflected back to the sealant by the reflective layer.

In this embodiment, if the reflective layer is the first reflective layer (that is, the reflective layer is provided on the surface of the color filter substrate in the periphery region facing the sealant), the width of the first reflective layer is 1.1 to 1.7 times larger than the width of the sealant, and preferably, the width of the first reflective layer is 1.5 times larger than the width of the sealant. In this case, the utilization ratio of the UV light can be improved by the first reflective layer. In addition, since the first reflective layer partially overlaps with the black matrix layer on the color filter substrate, the UV light can be prevented from entering into the black matrix layer by the first reflective layer, and thus the adverse influence of the UV light on the black matrix layer can be decreased and the defects in the LCD panel can be decreased.

In addition, in this embodiment, if the reflective layer is the second reflective layer (that is, the reflective layer is formed on the surface of the array substrate in the periphery region opposite to the sealant), the width of the second reflective layer is 0.9 to 1.4 times larger than the width of the sealant, and preferably, the width of the second reflective layer is substantially equal to that of the sealant. In this case, the utilization ratio of the UV light can be improved by the second reflective layer. In addition, in the operation process of the LCD panel, the light from the backlight can be blocked from entering into the sealant by the second reflective layer, and thus the adverse influence of long-time light irradiation and heat accumulation on the sealant can be decreased and the defects in the LCD panel can be decreased.

In the LCD panel and manufacturing method thereof are provided according to the invention, the reflective layer is provided in the periphery region of the color filter substrate or in the periphery region of the array substrate. In this way, the utilization ratio of the UV light for curing the sealant can be improved, the time for curing the sealant can be shortened and the probability that the liquid crystal layer is contaminated by un-cured sealant can be decreased. In addition, in the case that the reflective layer is provided on the array substrate, in the operation process of the LCD panel, the light from the backlight can be blocked from entering into the sealant, and thus the adverse influence of long-time light irradiation and heat accumulation on the sealant can be decreased and the defects in the LCD panel can be decreased.

It should be appreciated that the embodiments described above are intended to illustrate but not limit the present invention. Although the present invention has been described in detail herein with reference to the preferred embodiments, it should be understood by those skilled in the art that the present invention can be modified and some of the technical features can be equivalently substituted without departing from the spirit and scope of the present invention.

What is claimed is:

1. A liquid crystal display panel, comprising:
a first substrate and a second substrate bonded to each other;
a liquid crystal layer filled between a display region of the first substrate and a display region of the second substrate; and
a sealant formed between a periphery region of the first substrate and a periphery region of the second substrate,
wherein a reflective layer is formed in the periphery region of the first substrate or in the periphery region of the second substrate, and the reflective layer is adapted to reflect UV light to the sealant in a process of assembling the first substrate and the second substrate.

2. The liquid crystal display panel according to claim 1, wherein the first substrate is a color filter substrate, and the reflective layer and the sealant are formed on a same side of the color filter substrate.

3. The liquid crystal display panel according to claim 2, wherein a width of the reflective layer is 1.1 to 1.7 times larger than a width of the sealant.

4. The liquid crystal display panel according to claim 2, wherein the reflective layer partially overlaps with the sealant.

5. The liquid crystal display panel according to claim 4, wherein a width of the reflective layer is larger than that of the sealant.

6. The liquid crystal display panel according to claim 2, wherein a width of the reflective layer is equal to that of a UV light irradiation region.

7. The liquid crystal display panel according to claim 1, wherein the second substrate is an array substrate, and the reflective layer and the sealant are respectively provided on two opposed sides of the array substrate.

8. The liquid crystal display panel according to claim 7, wherein a width of the reflective layer is 0.9 to 1.4 times larger than a width of the sealant.

9. The liquid crystal display panel according to claim 1, wherein the reflective layer is formed by a metal material selected from the group consisting of aluminum, copper, and alloy of molybdenum and aluminum.

10. The liquid crystal display panel according to claim 1, wherein a thickness of the sealant is 0.1 μm to 0.4 μm.

11. A method of manufacturing a liquid crystal display panel, comprising:
preparing a first substrate and a second substrate, wherein a reflective layer is formed in a periphery region of the first substrate or in a periphery region of the second substrate;
applying a sealant in the periphery of one of the first substrate and the second substrate, dropping liquid crystal molecules on a display region of the other one of the first substrate and the second substrate, and attaching the first substrate and the second substrate to each other; and
curing the sealant by UV light so that the first substrate and the second substrate are bonded together, wherein the UV light incident on the reflective layer is reflected back to the sealant by the reflective layer.

12. The method of manufacturing the liquid crystal display panel according to claim 11, wherein the first substrate is a color filter substrate, and the reflective layer and the sealant are formed on a same side of the color filter substrate.

13. The method of manufacturing the liquid crystal display panel according to claim 12, wherein a width of the reflective layer is 1.1 to 1.7 times larger than a width of the sealant.

14. The method of manufacturing the liquid crystal display panel according to claim 12, wherein the reflective layer partially overlaps with the sealant.

15. The method of manufacturing the liquid crystal display panel according to claim 14, wherein a width of the reflective layer is larger than that of the sealant.

16. The method of manufacturing the liquid crystal display panel according to claim 12, wherein a width of the reflective layer is equal to that of a UV light irradiation region.

17. The method of manufacturing the liquid crystal display panel according to claim 11, wherein the second substrate is an array substrate, and the reflective layer and the sealant are respectively provided on two opposed sides of the array substrate.

18. The method of manufacturing the liquid crystal display panel according to claim 17, wherein a width of the reflective layer is 0.9 to 1.4 times larger than a width of the sealant.

19. The method of manufacturing the liquid crystal display panel according to claim 11, wherein the reflective layer is formed by a metal material selected from the group consisting of aluminum, copper, and alloy of molybdenum and aluminum.

20. The method of manufacturing the liquid crystal display panel according to claim 11, wherein a thickness of the sealant is 0.1 μm to 0.4 μm.
